(19) United States
(12) Patent Application Publication
(10) Pub. No.: US 2015/0214626 A1
(43) Pub. Date: Jul. 30, 2015

(54) TUNABLE ANTENNA

(71) Applicant: ASKEY COMPUTER CORP., NEW TAIPEI CITY (TW)

(72) Inventors: Chien-Sheng Liu, Chiayi County (TW); Yu-Chien Chan, New Taipei City (TW)

(21) Appl. No.: 14/558,734

(22) Filed: Dec. 3, 2014

(30) Foreign Application Priority Data
Jan. 28, 2014 (TW) 103103294

(51) Int. Cl. H01Q 9/04

(52) U.S. Cl. CPC H01Q 9/0442

(57) ABSTRACT

A tunable antenna including a first radiation element, a shorting element, a feeding element, and an impedance matching circuit is provided. The first radiation element provides a first resonant path, so that the tunable antenna covers a first band. The first band includes a plurality of sub-bands. The shorting element is electrically connected to the first radiation element and has a ground point. The feeding element is electrically connected to the first radiation element and has a feeding point. The impedance matching circuit is electrically connected to the shorting element and adjusts impedance of the tunable antenna according to a control signal, so that the tunable antenna is switched between the sub-bands.

### CROSS-REFERENCE TO RELATED APPLICATION

This application claims the priority benefit of Taiwan application serial no. 103103294, filed on Jan. 28, 2014. The entirety of the above-mentioned patent application is hereby incorporated by reference herein and made a part of this specification.

### BACKGROUND OF THE INVENTION

1. Field of the Invention

The invention relates to an antenna. More particularly, the invention relates to a tunable antenna.

2. Description of Related Art

Recently, to satisfy consumers' needs, mobile communication services provided by electronic apparatuses become more and more diverse. In response thereto, the electronic apparatuses are required to have corresponding antennas for supporting the diverse mobile communication services. There are various types of antennas, among which a tunable antenna characterized by broad or multiple bands has been extensively applied in a variety of electronic apparatuses.

According to the related art, different impedance matching circuits corresponding to different resonant frequencies are configured at the feeding end of the tunable antenna in most cases, and a switch module is applied to switch the feeding end of the antenna to different impedance matching circuits. This often reduces the antenna efficiency of the tunable antenna and requires the switch module and plural impedance matching circuits in order to achieve favorable impedance matching of the tunable antenna, thus limiting miniaturization of the electronic apparatuses.

### SUMMARY OF THE INVENTION

The invention is directed to a tunable antenna which electrically connects an impedance matching circuit to a shorting element, so as to enhance the antenna efficiency of the tunable antenna and advance the miniaturization of an electronic apparatus.

In an embodiment of the invention, a tunable antenna including a first radiation element, a shorting element, a feeding element, and an impedance matching circuit is provided. The first radiation element provides a first resonant path, such that the tunable antenna covers a first band. The first band includes a plurality of sub-bands. The shorting element is electrically connected to the first radiation element and has a ground point. The feeding element is electrically connected to the first radiation element and has a feeding point. The impedance matching circuit is electrically connected to the shorting element and adjusts impedance of the tunable antenna according to a control signal, such that the tunable antenna is switched between the sub-bands.

In view of the above, the impedance matching circuit is electrically connected to the shorting element according to an embodiment of the invention. Thereby, the tunable antenna in any sub-band can be characterized by satisfactory impedance matching, which is further conducive to the miniaturization of the electronic apparatus. Besides, subject to the impedance matching circuit, the radiation energy of the tunable antenna may be focused on one single sub-band, and thereby the antenna efficiency of the tunable antenna can be improved.

Several exemplary embodiments accompanied with figures are described in detail below to further describe the invention in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic diagram illustrating a tunable antenna according to an embodiment of the invention.

FIG. 2 is a schematic diagram illustrating a tunable antenna according to another embodiment of the invention.

### DETAILED DESCRIPTION OF DISCLOSED EMBODIMENTS

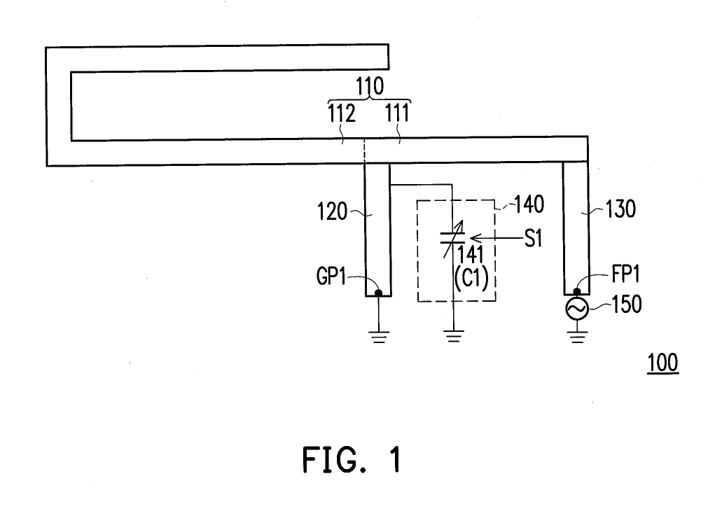

FIG. 1 is a schematic diagram illustrating a tunable antenna according to an embodiment of the invention. With reference to FIG. 1, the tunable antenna 100 is an inverted-F antenna and includes a first radiation element 110, a shorting element 120, a feeding element 130, and an impedance matching circuit 140. The first radiation element 110 includes a first connection section 111 and a second connection section 112.

As to the overall configuration, the first connection section 111 has a first end and a second end. The first end of the first connection section 111 is electrically connected to a first end of the feeding element 130, and the second end of the first connection section 111 is electrically connected to a first end of the shorting element 120. Besides, the second connection section 112 has a first end and a second end as well. The first end of the second connection section 112 is electrically connected to the second end of the first connection section 111, and the second end of the second connection section 112 is an open end. A second end of the feeding element 130 has a feeding point FP1, and the feeding element 130 receives a feeding signal 150 through the feeding point FP1. A second end of the shorting element 120 has a ground point GP1, and the shorting element 120 is electrically connected to a ground through the ground point GP1. Besides, the impedance matching circuit 140 is electrically connected to the shorting element 120.

As to operation, the first radiation element 110 provides a first resonant path. For instance, the first connection section 111 and the second connection section 112 are connected with each other to form the first resonant path. Thereby, under the excitation by the feeding signal 150, the feeding element 130, the shorting element 120, and the first connection section 111 form a current loop, and the tunable antenna 10 may provide a resonant mode through the first resonant path and further cover the first band. The first band includes a plurality of sub-bands.

It should be noted that the impedance matching circuit 140 may adjust impedance matching of the tunable antenna 100 according to a control signal S1, such that the tunable antenna 100 can be switched between the sub-bands of the first band. That is, under the control of the impedance matching circuit 140, the operation frequency of the tunable antenna 100 can be shifted by one frequency offset, which further allows the tunable antenna 100 to be switched to one of the sub-bands. Namely, in response to the control of the impedance matching circuit 140, the tunable antenna 100 may be switched between the sub-bands.

For instance, the frequency range of the first band covered by the tunable antenna is 824 MHz-960 MHz, for instance. Besides, the first band includes four sub-bands of which the frequency range is 824 MHz-858 MHz, 858 MHz-892 MHz, 892 MHz-926 MHz, and 926 MHz-960 MHz, respectively. The impedance matching circuit 140 may adjust the impedance matching of the tunable antenna 100, such that the tunable antenna may be switched to 824 MHz-858 MHz, 858 MHz-892 MHz, 892 MHz-926 MHz, or 926 MHz-960 MHz. Namely, under the control of the impedance matching circuit 140, the tunable antenna 100 may be switched between the four sub-bands.

The tunable antenna 100 with the impedance matching circuit 140 can achieve favorable impedance matching in any sub-band. Practically, the tunable antenna 100 is conducive to the miniaturization of the electronic apparatus. In addition, since the tunable antenna 100 may be switched to different sub-bands through the impedance matching circuit 140, the radiation energy of the tunable antenna 100 may be focused on one single sub-band, and thereby the antenna efficiency of the tunable antenna 100 can be improved.

The impedance matching circuit 140 includes an impedance element 141. The impedance element 141 has a first end and a second end. The first end of the impedance element 141 is electrically connected to the shorting circuit 120, and the second end of the impedance element 141 is electrically connected to a ground. As to operation, an impedance value of the impedance element 141 is changed according to the control signal S1, which correspondingly changes the impedance matching of the tunable antenna 100. The impedance element 141 may be a variable capacitor C1, for instance. As the impedance value of the variable capacitor C1 decreases, the tunable antenna 100 may be switched to the sub-band with the relatively higher frequency. In another embodiment of the invention, the impedance element 141 may be a variable inductor, for instance. FIG. 1 exemplifies several ways to implement the impedance matching circuit 140, which should however not be construed as limitations to the invention. For instance, the impedance matching circuit 140 may be constituted by plural impedance elements.

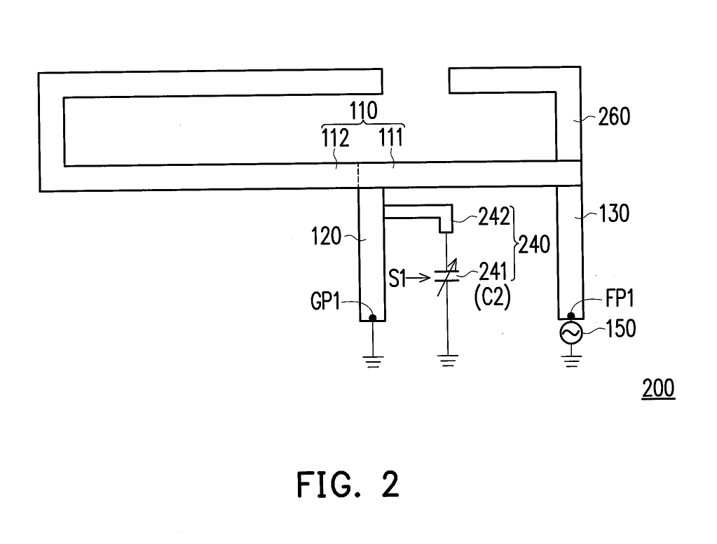

FIG. 2 is a schematic diagram illustrating a tunable antenna according to another embodiment of the invention. The tunable antenna 200 depicted in FIG. 2 is similar to the tunable antenna 100 depicted in FIG. 1, while the main difference therebetween lies in that the tunable antenna 200 depicted in FIG. 2 further includes a second radiation element 260, and the impedance matching circuit 240 shown in FIG. 2 includes the impedance element 241 and the conductive line 242.

Specifically, the second radiation element 260 is electrically connected to the first end of the first connection section 111, and the second radiation element 260 provides a second resonant path. Through the second resonant path, the tunable antenna 200 may provide another resonant mode and cover a second band. As such, the tunable antenna 200 not only can be operated in the first band but also can be operated in the second band through the second radiation element 260. That is, the tunable antenna 200 is a dual-band inverted-F antenna.

In addition, according to the design requirements, people having ordinary skill in the art may modify the length of the first resonant path and the length of the second resonant path based on actual design demands and thereby adjust the frequencies of the first and second bands. For instance, in the embodiment shown in FIG. 2, the length of the first resonant path is greater than the length of the second resonant path. At this time, the frequency of the first band is lower than that of the second band. Under the control of the impedance matching circuit 240, the tunable antenna 200 may be switched between the sub-bands in the lower band. By contrast, in another embodiment, if the length of the first resonant path is less than the length of the second resonant path, the tunable antenna 200 under the control of the impedance matching circuit 240 may be switched between the sub-bands in the higher band.

A first end of the conductive line 242 in the impedance matching circuit 240 is electrically connected to the shorting element 120. The impedance element 241 has a first end and a second end. The first end of the impedance element 241 is electrically connected to a second end of the conductive line 242, and the second end of the impedance element 241 is electrically connected to a ground. As to operation, an impedance value of the impedance element 241 is changed according to the control signal S1, which correspondingly adjusts the impedance of the tunable antenna 200. In addition, the impedance element 241 is a variable capacitor C2, for instance. As the impedance value of the variable capacitor C2 decreases, the tunable antenna 200 may be switched to the sub-band with the relatively higher frequency. In another embodiment of the invention, the impedance element 241 may be a variable inductor, for instance.

Note that the length of the conductive line 242 is proportional to the frequency offset of the tunable antenna 200 while the tunable antenna 200 is switched between the sub-bands. That is, people having ordinary skill in the art may modify the length of the conductive line based on actual design demands, such that the tunable antenna 200 may be switched to the required sub-band according to the control signal S1. The detailed descriptions of other elements shown in FIG. 2 are included in the above-mentioned embodiments and thus are not repeated herein.

To sum up, the impedance matching circuit is electrically connected to the shorting element according to an embodiment of the invention. Thereby, the tunable antenna in any sub-band can be characterized by satisfactory impedance matching, which is further conducive to the miniaturization of the electronic apparatus equipped with the tunable antenna. Moreover, the radiation energy of the tunable antenna may be focused on one single sub-band, and thereby the efficiency of the tunable antenna can be improved.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A tunable antenna comprising:
a first radiation element providing a first resonant path, such that the tunable antenna covers a first band, wherein the first band comprises a plurality of sub-bands;
a shorting element electrically connected to the first radiation element, the shorting element having a ground point;
a feeding element electrically connected to the first radiation element, the feeding element having a feeding point; and
an impedance matching circuit electrically connected to the shorting element, the impedance matching circuit adjusting impedance matching of the tunable antenna according to a control signal, such that the tunable antenna is switched between the sub-bands.

2. The tunable antenna according to claim 1, wherein the impedance matching circuit comprises an impedance element having a first end and a second end, the first end of the impedance element is electrically connected to the shorting circuit, the second end of the impedance element is electrically connected to a ground, and an impedance value of the impedance element is changed according to the control signal.

3. The tunable antenna according to claim 1, wherein the impedance matching circuit is a variable capacitor or a variable inductor.

4. The tunable antenna according to claim 1, wherein the impedance matching circuit comprises:
a conductive line having a first end electrically connected to the shorting element; and
an impedance element having a first end and a second end, wherein the first end of the impedance element is electrically connected to a second end of the conductive line, the second end of the impedance element is electrically connected to a ground, and an impedance value of the impedance element is changed according to the control signal.

5. The tunable antenna according to claim 4, wherein a length of the conductive line is proportional to a frequency offset of the tunable antenna while the tunable antenna is switched between the sub-bands.

6. The tunable antenna according to claim 1, wherein the first radiation element comprises:
a first connection section having a first end and a second end, the first end of the first connection section being electrically connected to a first end of the feeding element, the second end of the first connection section being electrically connected to a first end of the shorting element, wherein the feeding element, the shorting element, and the first connection section form a current loop; and
a second connection section having a first end and a second end, the first end of the second connection section being electrically connected to the second end of the first connection section, the second end of the second connection section is an open end, wherein the first connection section and the second connection section are configured to form the first resonant path, a second end of the feeding element has the feeding point, and a second end of the shorting element has the ground point.

7. The tunable antenna according to claim 6, further comprising:
a second radiation element electrically connected to the first end of the first connection section, the second radiation element providing a second resonant path, such that the tunable antenna covers a second band.

8. The tunable antenna according to claim 7, wherein a length of the first resonant path is greater than a length of the second resonant path.

9. The tunable antenna according to claim 1, wherein the tunable antenna is an inverted-F antenna.
